(19) United States
(12) Patent Application Publication
(10) Pub. No.: US 2010/0180913 A1
(43) Pub. Date: Jul. 22, 2010

(54) METHODS FOR IN-SITU CHAMBER CLEANING PROCESS FOR HIGH VOLUME MANUFACTURE OF SEMICONDUCTOR MATERIALS

(76) Inventors: Chantal Arena, Mesa, AZ (US); Christiaan J. Werkhoven, Gilbert, AZ (US); Ronald Thomas Bertram, JR., Mesa, AZ (US); Andrew D. Johnson, Doylestown, PA (US); Vasil Vorsa, Coopersburg, PA (US); Robert Gordon Ridgeway, Quakertown, PA (US); Peter J. Maroulis, Alburtis, PA (US)

Correspondence Address: WINSTON & STRAWN LLP;PATENT DEPARTMENT, 1700 K STREET, N.W., WASHINGTON, DC, 20006, US

(21) Appl. No.: 12/602,740

(22) PCT Filed: Dec. 5, 2008
(86) PCT No.: PCT/US08/85707

§ 371 Date: Dec. 2, 2009

Related U.S. Application Data
(60) Provisional application No. 61/015,498, filed on Dec. 20, 2007.

(51) Int. Cl. C23G 1/00; B05C 11/00

(52) U.S. Cl. 134/2; 118/712

(57) ABSTRACT

The present invention is related to the field of semiconductor processing equipment and methods and provides, in particular, methods and apparatus for in-situ removal of undesired deposits in the interiors of reactor chambers, for example, on chamber walls and elsewhere. The invention provides methods according to which cleaning steps are integrated and incorporated into a high-throughput growth process. Preferably, the times when growth should be suspended and cleaning commenced and when cleaning should be terminated and growth resumed are automatically determined based on sensor inputs. The invention also provides reactor chamber systems for the efficient performance of the integrated cleaning/growth methods of this invention.

### FIELD OF THE INVENTION

The present invention is related to the field of semiconductor processing equipment and methods, and provides, in particular, methods and apparatus for in-situ removal of undesired deposits in the interiors of reactor chambers, for example, on chamber walls and elsewhere.

### BACKGROUND OF THE INVENTION

Halide (or hydride) vapor phase epitaxy (HVPE) is an epitaxial process for rapidly growing compound semiconductor materials, in particular, Group III-V compound semiconductors such as GaN. Because of the high growth rates achieved by HVPE, it is ideal for production of thick, free-standing GaN layers. HVPE processes grow epitaxial GaN by reacting a Ga-containing precursor gas and an N-containing precursor gas at the surface of a heated substrate (e.g., usually 800-1200° C.). Most HVPE processes produce a GaCl precursor gas by passing HCl over heated, liquid Ga held in the reactor chamber. The N-containing precursor gas is usually NH₃. In some HVPE processes, the Ga-containing precursor is GaCl₃ vapor introduced into the reactor chamber from an external source.

However, during HVPE processes, material can grow or deposit, not only on the substrate, but also on undesired locations throughout the reactor chamber, e.g. on the reactor walls, on and around the susceptor, and elsewhere, and cause reduced throughput, increased costs, and even reactor damage. For example, undesired deposits, wherever they are located in the reactor chamber, can release particles, flakes, and so forth, which, if they lodge on the substrate, can render it undesirable, or even useless, for its intended purposes. Undesired deposits on and around a rotating susceptor can increase friction or even cause adhesion with stationary structures. Undesired deposits on the chamber walls can act as thermal insulators so that the heating/cooling times of the chamber are extended, thus reducing reactor throughput. In the case of quartz reactor chambers heated by IR radiation, undesired deposits on chamber walls can cause the quartz chamber itself to de-vitrify. Under typical operating conditions the IR radiation penetrates through the walls of the reactor chamber for heating of internal reactor components. However, the build up of undesirable deposits on the reactor walls increases IR absorption thereby increasing the wall temperature sufficiently for devitrification to occur.

In addition, it is often advantageous to perform a reactor chamber clean prior to each growth run executed in the system. Ensuring the chamber is clean and free of contaminates not only improves wafer quality but also resets the system into a known state from which all runs can be initiated. Consequently, the reset reactor state results in an increased repeatability of growth process from run to run, ensuing greater growth stability. The methods and systems of the invention outlined herein ensure that the duration of the cleaning processes is at a minimum, therefore improving material quality whilst minimizing the impact on wafer through put.

Therefore, reactor chambers, especially those used for HVPE processes must be periodically cleaned. Wet cleaning is one known reactor chamber cleaning method in which the chamber is exposed to cleaning solutions, e.g., strong acids, which dissolve the undesired deposits. Wet methods have disadvantages including time consuming disassembly and reassembly of the reactor subsystem, residual contamination left by cleaning solutions, and so forth. To remedy these disadvantages, dry cleaning methods have been developed in which undesired deposits are removed from the reactor chamber in situ. Deposits are often removed by converting them into a gas using reactive plasmas generated in the reactor chamber, or reactive gases introduced into the chamber, and the like.

In more detail, reactive gases used in dry cleaning processes are selected to lead to gas phase products upon reacting with the undesired deposits. In many cases, reactor chambers are heated to promote dissolution of the undesired deposits. Reactive gases can be introduced into a reactor chamber continuously, quasi-statically, and according to other known methods. In one known continuous method, fresh reactive gases are flowed continuously into the chamber and spent reactive gases along with reaction products of the undesired deposits are continuously exhausted from the chamber. See, e.g., U.S. Pat. No. 4,498,953, which is included herein by reference in its entirety for all purposes. In one known quasi-static method, cleaning proceeds by one or more cycles; in each cycle, an amount of fresh reactive gases are first introduced into the chamber, then the gases are retained statically in the chamber to permit reaction with undesired deposits; then after a period of time, the spent reactive gases along with reaction products of the undesired deposits are exhausted from the chamber. See, e.g., U.S. Pat. No. 6,620,256, which is included herein by reference in its entirety for all purposes.

Generally, processes for cleaning the reactor chamber are arranged and performed separately from growth processes conducted in the chamber. For example, cleaning is performed after growth is complete. However, certain growth processes proceed in separate steps, and reactor cleaning can be performed between the separate steps. U.S. Pat. No. 6,290,774, which is included herein by reference in its entirety for all purposes, describes a process for growing relaxed GaN layers on substrates in several separate steps, where in each step, a thin GaN layer is grown on the substrate at higher growth temperatures, and then the substrate is cooled to lower ambient temperatures to induce and relax thermal stresses. This patent further describes conducting chamber cleaning between the separate steps, that is, the chamber is cleaned after the substrate has been cooled in the previous step and before it is heated to growth temperature in the subsequent step.

However, it has been found that the known dry cleaning methods are not suitable for high-throughput HVPE material growth. Generally, the known methods are, by themselves, too inefficient, and also are too disruptive of the primary HVPE growth process. What are needed are more efficient dry cleaning methods that can be more tightly integrated into a primary HVPE process. With such dry cleaning processes, high-throughput production of thick layers of, in particular, Group III-V materials such as GaN, could be performed in reactor chambers maintained sufficiently free of undesired deposits so that the materials produced are of suitable qualities.

### SUMMARY OF THE INVENTION

The present invention provides methods of chemical vapor deposition (CVD) and related reactor chamber subsystems, suited to the provided methods, by which semiconductor materials can be grown at high volume, with increased quality and to an increased thickness. Specifically, the methods allow prolonged periods of material growth without deterioration of material quality due to build-up of undesired deposits on the reactor chamber walls and on its internal components. When it is necessary to ameliorate undesired deposits, the methods rapidly cycle a reactor chamber from growth mode to an in situ cleaning mode, and then, when the undesired deposits have been sufficiently ameliorated, back to growth mode. The subsystems of the invention allow cycling between growth modes and cleaning modes to be rapid and efficient. It is believed that rapid cycling of the reactor chamber between growth processes and in-situ cleaning processes is not possible in the prior art.

In particular, during the growth mode, the invention preferably automatically, senses when a reactor chamber requires cleaning, and also, during the cleaning mode, senses when a reactor chamber is sufficiently clean. Cleaning is generally carried out at higher temperatures. Preferred subsystems provide the necessary sensors. Preferred cleaning sensors monitor the composition of gases exhausted from the reactor during the cleaning mode. Using the latter sensor, cleaning can be determined to be sufficiently complete when the level of products of the cleaning reaction is sufficiently low, e.g., at trace levels.

Generally, a working substrate is removed from the reactor chamber during cleaning to avoid chemical damage by the cleaning reagents, and further its removal/replacement generally is carried out at lower temperatures to avoid thermal damage. Preferred reactor chamber subsystems have means, e.g., controllable load lock, controllable robot arm, wafer pick-up tool and automatic control system, to rapidly perform, the essentially, mechanical substrate transfer. In preferred embodiments the controllable robot arm is capable of further increasing the rate of rapid cycling between reactor growth/clean modes and hence reactor throughput by permitting the loading and unloading of a substrate at elevated temperatures without incurring a deterioration in wafer surface quality.

Preferably a load lock opens into a load chamber, intermediate chamber, or the like, having a controlled atmosphere so that the substrate, when removed from the reactor chamber, can be held in controlled conditions out of contact with the ambient atmosphere.

In some (but not all) embodiments, cycling between growth and cleaning modes can require significant temperature decreases or increases. A preferred reactor chamber, therefore, has low thermal mass, such as reactor chambers made of, e.g., quartz and heated by infrared (IR) radiation, so that such temperature changes can be rapidly carried out. Further, preferred substrates are selected so that these temperature changes can be minimized. One class of substrates that is relatively resistant to thermal stresses comprises materials with sufficiently matched coefficients of thermal expansion (CTE) to a particular target growth material.

In preferred embodiments, the invention is applied to the growth of Group III-V semiconductor compounds, and in particular to Group III-nitride compounds such as GaN, by halide (or hydride) vapor phase epitaxy (HVPE). HVPE allows rapid growth of thick layers of Group III-nitride compounds, but such rapid growth can lead to accumulation of undesired deposits on the reactor walls and on its internal components, e.g., a growth wafer or susceptor. Accordingly, use of this invention in its preferred embodiments can provide the ability to grow very thick layers of Group III-nitride compounds without being limited by deterioration of reactor chamber cleanliness and without having to expose the working substrate to the ambient atmosphere.

For example, for Ga—V compounds (e.g., GaN or GaAs) during growth mode, reagent gases comprising a Ga-containing compound and a N-containing compound are introduced into the heated reactor chamber, and react to deposit a Ga-containing material. Preferably, the Ga-containing reagent gas comprises a Ga chloride introduced into the chamber from a source exterior to the chamber. When undesired deposits have accumulated to an unacceptable level, the reactor chamber subsystem switches (preferably automatically) to the cleaning mode. During cleaning mode, cleaning gases comprising a halogen or halogen compound are introduced into the heated reactor chamber and react with the undesired deposits to form gaseous reaction products. The working substrate with Ga-containing material grown thereon is removed during cleaning. The flow of cleaning gases is stopped once the exhaust gas sensor indicates that the gases exhausting from the reactor chamber comprise little or no Ga-containing compounds. Then, the reactor chamber subsystem switches (preferably automatically) back to the growth mode, and the growth-cleaning cycle is repeated until a desired amount of Ga-containing material has been deposited on the substrate. These methods are preferably carried out with reactor chamber subsystems having the above-described preferred features.

In more detail, the present invention provides preferred embodiments with a method for growing a selected amount of a semiconductor material on a substrate in a reactor chamber which includes the step of growing the semiconductor material on the substrate by a chemical vapor deposition (CVD) process; and removing undesired deposits within the reactor chamber by an in situ cleaning process, wherein the steps of growing and removing are repeated in a manner so that the selected amount of material is grown on the substrate while the amount of undesired deposits in the reactor chamber is maintained within an acceptable range.

In further preferred embodiments, the CVD process can be a halide vapor phase epitaxy process that grows on the substrate one or more compounds of one or more Group III elements; the in situ cleaning process can include converting undesired deposits to gaseous products which are exhausted from the reactor chamber; the acceptable range of accumulation is such that the material grown on the substrate has a quality sufficient for its intended use or is substantially free of contamination arising from the undesired deposits; the growth step, or the removal step, or both steps, can be performed for periods of time selected so that the amount of undesired deposits is maintained within an acceptable range; the amount of undesired deposits can be detected automatically, and the in situ cleaning process is performed in dependence on the automatically-detected amount undesired deposit so that the amount of undesired deposits is maintained within an acceptable range; and the substrate can be transferred from the reactor chamber during the in situ cleaning process with reactor chamber temperature during substrate transfer set within a replacement/removal temperature range such that thermal damage to the substrate is not likely.

In further preferred embodiments, the present invention provides a method for in situ cleaning of deposits from the interior of a reactor chamber, which is useful in semiconductor equipment, that includes exposing the interior of the reactor chamber to a gas which reacts with the undesired deposits to form gaseous reaction products, detecting automatically levels of the gaseous reaction products, optionally by performing a spectral measurement, and continuing the gas exposure until the automatically detected levels of reaction products indicate that the amount of undesired deposits is within an acceptable range.

In further preferred embodiments, the levels of gaseous reaction products can be detected in gases flowing in the reactor-chamber exhaust after having flowed through the body of the reactor chamber; the undesired deposits can comprise one or more Group III-V compounds, the cleaning gases can comprise one or more halogen compounds; the reactor chamber can be heated during the gas exposure to sufficient temperatures (which can be below, or about, or above the temperatures that prevailed in the chamber during formation of the undesired deposits.

In further preferred embodiments, the present invention provides processing equipment for growing a selected amount of a semiconductor material on a substrate that includes a reactor subsystem with a reactor chamber, the subsystem being directed by control signals to carry out various semiconductor process, a gas sensor for generating signals responsive to the composition of gases discharged from the chamber, and an automatic controller for generating control signals to direct the reactor subsystem, the control signals being generated, at least in part, in dependence on the gas-sensor signals.

In further preferred embodiments, the control signals include cleaning control signals that carry out an in situ process for cleaning undesired deposits from within the reactor chamber, and wherein the in situ cleaning process is continued until the gas-sensor signals indicate that the remaining amount of undesired deposits within the reactor chamber is within an acceptable range; the in situ cleaning process can includes particular steps of exposing the reactor chamber to one or more cleaning gases that react with the undesired deposits within the reactor chamber to form gaseous reaction products, and discharging the reaction products from the reactor chamber.

In further preferred embodiments, the control signals include growth control signals that carry out CVD processes for growing semiconductor material on the substrate within the chamber, and wherein the controller repetitively generates the growth-control signals and the cleaning-control signals in a manner so that the selected amount of material is grown on the substrate while the amount of undesired deposits in the reactor chamber is maintained within an acceptable range; preferably, the equipment can also include a deposit sensor for generating signals responsive to undesired deposits within the reactor chamber, and wherein the CVD process is continued until the deposit-sensor signals indicate that the reactor chamber should be cleaned; the CVD process can heat the reactor to a growth temperature range and flow through the reactor chamber one or more gases that react to deposit the material on the substrate; the precursor gases comprise halogen compounds of a Group III element, and the growth temperature can range from about 800° C. to about 1150° C.

In further preferred embodiments, the equipment also includes a substrate-transfer means, optionally a robot arm, directed by transfer control signals for performing processes for transferring a substrate into or out of the reactor chamber, the substrate being transferred out of the reactor chamber prior to the in situ cleaning process and transferred back into the reactor chamber subsequent to the in situ cleaning process; the transfer process that is performed preferably includes maintaining the reactor at a replacement/removal temperature during the substrate transfer, the replacement/removal temperature being such that thermal damage to the substrate during transfer is unlikely, and for example can be from about 600° C. to about 750° C.

Headings are used herein for clarity only and without any intended limitation. A number of references are cited herein, the entire disclosures of which are incorporated herein, in their entirety, by reference for all purposes. Further, none of the cited references, regardless of how characterized above, is admitted as prior to the invention of the subject matter claimed herein.

### BRIEF DESCRIPTION OF THE DRAWINGS

The present invention may be understood more fully by reference to the following detailed description of the preferred embodiment of the present invention, illustrative examples of specific embodiments of the invention and the appended figure in which:

FIGS. 1A-B illustrates embodiments of the methods of this invention;

FIG. 2 illustrates an exemplary embodiment reactor-chamber subsystem of this invention;

FIGS. 3A-B illustrates control methods of this invention; and

FIG. 4 illustrates an exemplary temperature profile of this invention.

### DETAIL DESCRIPTION OF THE PREFERRED EMBODIMENTS

The present invention provides efficient dry-cleaning methods for reactor chambers used for vapor-phase material growth processes, in particular for reactor chambers used for CVD (chemical vapor deposition), PECVD (plasma enhanced CVD), MBE (molecular beam epitaxy), and so forth, for the growth of semiconductor materials. The invention also provides methods for high-throughput, vapor-phase material growth that incorporates and integrates the provided cleaning methods so that the reactor chambers are kept sufficiently free of undesired deposits. The invention also includes apparatus for epitaxial growth that includes particular features directed to efficiently perform the provided methods.

Generally, the invention is applicable to vapor-phase growth processes for many types of materials, as will be apparent to those of skill in the art. In preferred embodiments, the materials of interest are “semiconductor materials”, a term which is used herein to refer to both active semiconductor materials (e.g., Si, SiGe, GaN, and so forth) as well as to additional materials used in component fabrication (e.g., SiO₂, W, and so forth). Semiconductor materials preferably include Group III-V compound materials, particularly Group III-nitride compound materials, and more preferably to pure and mixed nitrides of Ga, Al, and In.

The term “substrate” (or “wafer”) is used to refer to the base or foundation substance on which material is deposited, and also to the base or foundation material on which one or more layers have been grown. Substrates can have a homogenous or a heterogeneous composition, e.g., can include a plurality of layers of different materials. The semiconductor materials (or material generally) grown on a substrate can be similarly homogenous or heterogeneous.

Chambers are kept “sufficiently clean” if materials grown therein are sufficiently free of contamination so that they can be fabricated into electronic, optical, or opto-electronic components; a sufficiently clean reactor chamber has an “acceptable” level of undesired deposits. A level of deposits is “unacceptable”, and a reactor with such deposits is not sufficiently clean, if materials grown in a reactor chambers with that level of deposits are not suitable for their intended purpose. Whether or not a particular level of deposits is acceptable or unacceptable is controlled by several factors including required material quality, growth process, reactor chamber geometry, flow conditions in the reactor, etc., and can be determined by testing material quality as a function of level of undesired deposits while keeping other factors constant.

The following description is often focused on embodiments suitable for the growth of particular semiconductor materials, especially Group III-nitride materials such as GaN. However, this descriptive focus is only for conciseness and clarity. It should be understood that it does not limit the invention to the particular embodiments focused on.

By way of brief background, Group III-nitride compounds (either pure of mixed nitrides) are usually grown using either MOCVD (metal-organic CVD) or HVPE (hydride/halide vapor phase epitaxy). In MOCVD, the Group III-precursor, a metal-organic compound, and nitrogen precursor, usually NH₃, are introduced from outside the reactor chamber and flowed over a heated substrate supported by a susceptor where the Group III-nitride compound grows. In HVPE, the Group III-precursor is a metal chloride, which can either be introduced from outside the chamber, or can be produced inside the chamber by flowing HCl over the heated Group III-metal. The nitrogen precursor is again usually NH₃, and the substrate is heated to about 800-1100° C. HCl is a suitable etchant gas for both MOCVD and HVPE, and during cleaning, the reactor chamber is heated to near or beyond the Group III-nitride growth temperatures. H₂ is a gas with which to purge lingering etchant gases from the reactor chamber prior to resuming growth.

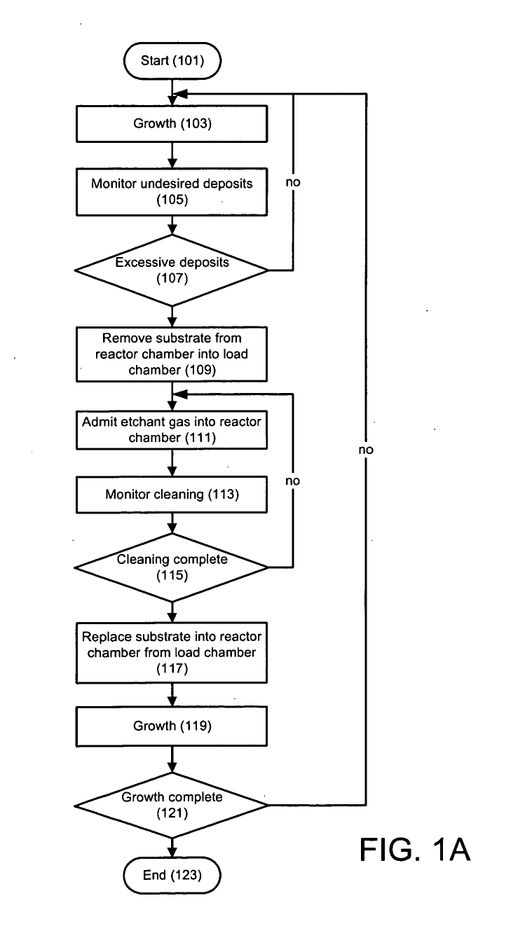

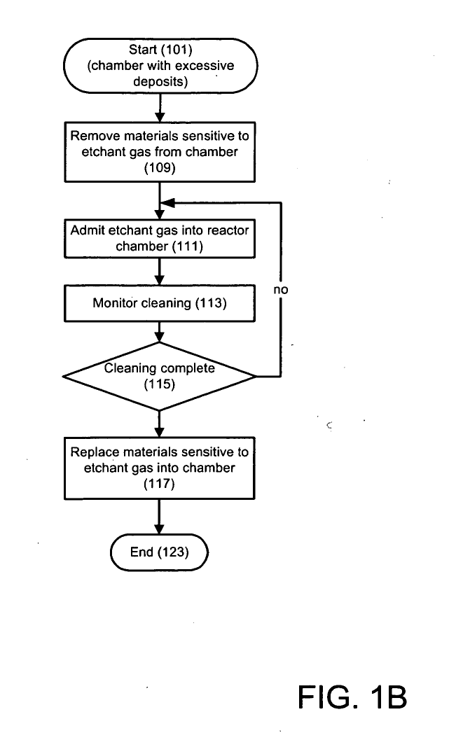

FIG. 1A illustrates an exemplary high-throughput growth method incorporating and integrating the reactor cleaning steps provided by the present invention. The growth method proceeds by performing growth 103 (e.g., epitaxial growth), interrupting the epitaxial growth process in order to clean the reactor chamber by flowing etchant gases 111, and then resuming growth process 119. During the cleaning period, it is preferred to flow the etchant gases in a continuous manner. In alternative embodiments, the etchant gas flows may be periodic so that the cleaning process includes a series of one or more separate cleaning cycles. In each such cleaning cycle, etchant gases are admitted to the chamber, retained in the chamber for a period of time, and then exhausted from the chamber. Since etchant gases capable of reacting with and removing undesired deposits can chemically damage or destroy a working substrate, it is preferable that working substrates be removed from the reactor chamber 109 prior to commencing the etchant gas flow. They are replaced in the reactor chamber 117 after the etchant gas flow is terminated and prior to the next growth step. After etchant gas flow has been terminated, residual etchant gases can be purged from the reactor chamber by, e.g., flowing a non-etchant gas.

During cleaning, a single etchant gas can be used, or a combination of etchant gases can be used, or different etchant gases can be used in succession. Etchant gases are chosen for their ability to react with undesired deposits under conditions compatible with the underlying growth process to form gas-phase products that can be readily exhausted from the chamber. In particular, etchant gases should not leave residues that can contaminate the growth process or lead to damage of the reactor chamber itself. For example, etchant gases can be selected to (thermodynamically) force the growth process to run backwards leading to dissolution of undesired deposits. The chamber may or may not need to be heated during etchant gas flow. In addition to HCl, preferred for Group III-nitride growth process, suitable etchant gases are often halogen containing, e.g. elemental halogens (e.g., F₂ and Cl₂) and compounds of halogens with hydrogen, other halogens, inert gases, rare gases, and the like (e.g., HCl; BCl₃; SiCl₄; ClF₃; NF₃; etc.). Etchant gases may be used in their native state or activated by passage through a plasma.

Growth steps 103 and 119 are repeated until material growth is complete 121, and cleaning step 111 is repeated with sufficient frequency and is continued for a sufficient duration so that undesired deposits are limited to acceptable levels throughout all the growth steps. Accordingly, during the process, it must be determined when undesired deposits have sufficiently accumulated so that growth should be interrupted and cleaning commenced; and it must also be determined when undesired deposits have been sufficiently dissolved so that cleaning can be terminated and growth resumed. One or both of these decisions can be made by an operator. For example, an operator can monitor (e.g., by visual inspection) the reactor chamber during growth, decide when undesired deposits have accumulated to an extent such that the chamber should be cleaned, and then trigger an interruption of growth and commencement of cleaning. The operator can then monitor (e.g., again by visual inspection) the reactor chamber during cleaning, decide when the chamber is sufficiently free of undesired deposits, and then trigger termination of etchant gas flow, purging of etchant gases from the chamber, and resumption of growth.

In preferred embodiments one or both of these decisions can be made automatically so that operator inattention or inefficiency need not delay an ongoing high-throughput growth process. In one embodiment, one or both of these decisions can be made according to elapsed time. For example, from experimentation and experience with a particular reactor chamber and a particular growth process performed with substantially fixed parameters (e.g., pressures, temperatures, flow rates, and the like), an elapsed time for the accumulation of undesired deposits to unacceptable levels can be determined. Similarly, an elapsed time can be determined for the dissolution of an acceptable level of undesired deposits from a particular reaction chamber in which a particular etchant gas is flowed at known flow rates, temperatures, and the like. Then, growth steps 103 and 119 can be performed for a time duration determined in dependence on the elapsed accumulation time, and cleaning step 111 can similarly be performed for a time duration determined in dependence on the elapsed dissolution time.

In more preferred embodiments, one or both of these decisions, when to interrupt growth and commence cleaning 107 and when to interrupt cleaning and resume growth 115, are made automatically in dependence on sensor signal inputs. For example, the decision when to interrupt growth 107 can be dependent on inputs from deposition sensors responsive to the amount of undesired deposits that have accumulated within a reactor chamber. When the deposition sensor signals indicate an unacceptable level of undesired deposits is imminent, growth can be automatically interrupted and cleaning can be triggered. The decision when to interrupt cleaning can also be made in dependence on inputs from the same deposit sensor. When the deposition sensor signals indicate that sufficiently little undesired deposit remains in the reactor, cleaning can be automatically interrupted and growth resumed.

However, the decision when to interrupt cleaning is preferably made in dependence on the composition of exhaust gases from the reactor chamber during cleaning, in particular, in dependence on the amount of products of the reaction between the etchant gases and the undesired deposits found in the exhaust. The complete composition need not be measured; it can be sufficient to measure markers, fingerprints, signatures, and the like that distinguish reaction products from other components of the exhaust. Also, such markers need not be continuously monitored; intermittent sampling can be sufficient. Such markers can include spectral characteristics of the exhaust. When the measured or sampled markers indicate that the level of deposit reaction products in the exhaust is sufficiently low, cleaning can be automatically interrupted and growth resumed. The decisions when to interrupt growth or cleaning steps can be made in other ways that will be apparent to those of routine skill in the art.

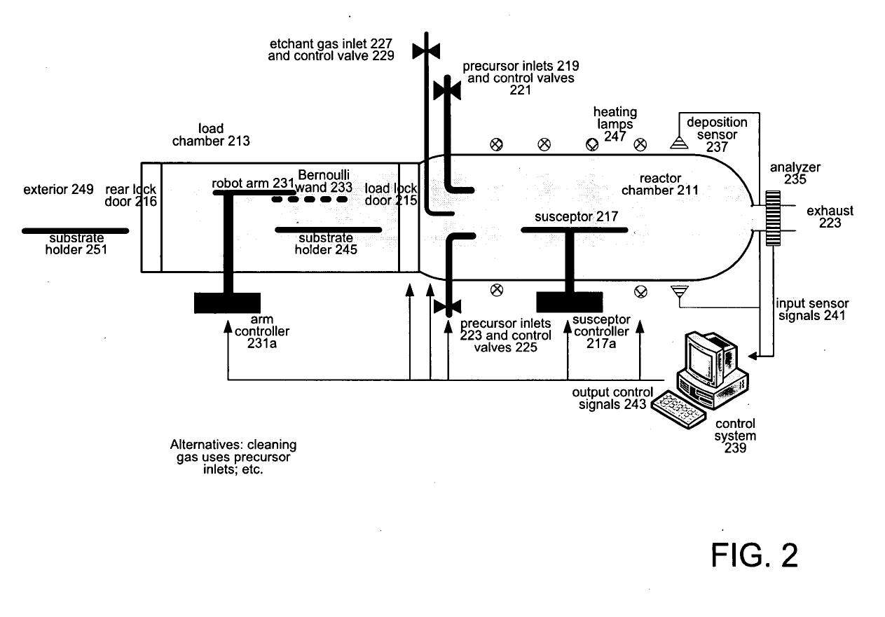

As discussed, substrates can be chemically damaged by etchant gases during cleaning, and must therefore be protected from exposure to these gases. In most embodiments, substrates are removed from the reactor chamber 109 prior to commencing cleaning and replaced in the reactor chamber 117 prior to resuming growth. These steps are essentially mechanical and require opening and closing the reactor and manipulating the substrate. Although these steps can be performed by manual operator action, such manual performance is not preferred during high-throughput growth processes. Inattention or inefficiencies of even well trained operators can introduce delays. Therefore, reactor chamber subsystems used in this invention preferably includes automatically controllable devices that perform substrate removal and replacement in response to control signals. Automatic implementation of these steps is further described with reference to FIG. 2, which illustrates an exemplary reactor chamber subsystem having such controllable devices.

FIG. 1A and its associated description have been largely directed to the incorporation and integration of the cleaning methods of this invention into high-throughput growth processes, where they are performed as part of an overall high-throughput growth process. However, these cleaning methods can be alternatively implemented. For example, FIG. 1B illustrates that these steps can also be performed separately in a stand-alone cleaning process. The process of FIG. 1B begins 101 with a chamber having an unacceptable or excessive level of undesired deposits from, e.g., a prior growth or other process conducted in the chamber. Optionally, monitoring sensors during the prior process could have determined that unacceptable or excessive undesired deposits had accumulated.

Chamber cleaning can be performed with the chamber in place, or the chamber could be removed and placed in a cleaning subsystem. Next, materials, e.g., growth substrates, sensitive to the etchant gas to be used are removed 109 from the chamber. Removed materials are replaced 117 when the cleaning is complete. The etchant gas (or gases) are now admitted 111 to the chamber as a continuous flow or as intermittent pulses. The progress of cleaning is monitored 113, preferable as above, by sensing gases exhausting from the chamber for markers of reaction products of the etchant gases and the undesired deposits. The markers can be spectroscopic characteristics of the exhaust gases. When cleaning is determined to be complete, e.g., by the level of reaction products in the exhaust gases falling to a sufficiently low level, the cleaning process ends 123. It will be apparent to one of skill in the art that the cleaning methods of this invention and their steps can be alternatively incorporated and integrated into other growth processes, or even into other processes, that are performed in a rector chamber, or can also be arranged differently in different standalone embodiments. These alternatives are within the scope of this invention.

The methods of this invention are advantageously implemented in connection with reactor chambers, reactor-chamber subsystems (and/or growth/deposition systems) with certain preferred features enabling automation of one or more steps of the cleaning methods. Preferred features include: sensors of reactor-chamber-exhaust gas composition; sensors of undesired deposits; controllable (e.g., robot) mechanisms for transfer of substrates to and from reactor chambers; selectable gas species for wafer pick-up components; controllable doors between the reactor chamber and its exterior; controllable etchant gas inlets; a load or intermediate chamber where substrates removed from a reactor chamber can be held out of contact with the ambient atmosphere; automatic control systems for receiving sensor signals and outputting control signals; and the like.

FIG. 2 illustrates an exemplary high-throughput reactor-chamber subsystem having the above features. Generally, reactor chamber 211 is constructed at least partially of quartz. Internal components, e.g., susceptor (or substrate holder) 217, are heated by IR radiation passing through the quartz portions of the reactor chamber from IR lamps 247. Such a reactor chamber has a low thermal mass, and can be heated and cooled more rapidly than chambers with, e.g., directly-heated, opaque walls. Precursor gases are admitted through schematically-illustrated inlets 219 and 223 which are controlled, preferably automatically, by valves 221 and 225 (or by mass-flow controllers, and the like). Precursor gas inlets are arranged so that the precursor gases flow over one or more substrates supported by the heated susceptor 217 where the gases react to deposit the growth material. The susceptor can remain stationary during growth, but more commonly, the susceptor is rotated by susceptor controller 217a. Spent precursor gases exit the chamber through exhaust 223.

Specific embodiments of such reactor chambers and associated subsystems with the above general features and directed to high-throughput growth of Group III-V-compound containing materials, e.g., GaN semiconductor material, are described in U.S. provisional patent applications Nos. 60/866,910 filed Nov. 22, 2006; 60/866,965 filed Nov. 22, 2006; 60/866,928 filed Nov. 22, 2006; 60/866,923 filed Nov. 22, 2006; 60/866,953 filed Nov. 22, 2006; 60/866,981 filed Nov. 22, 2006, all of which are incorporated herein by reference in their entireties for all purposes. The described embodiments use HVPE processes with external sources of a Group III-chloride precursor (e.g., GaCl₃) and include features which slow the accumulation of undesired deposits, e.g., reactor chambers walls kept at temperatures considerably below deposition temperature.

The illustrated reactor chamber also includes specific features useful for the methods of this invention. Certain preferred specific features are directed to the controllable admission of etchant gases. Etchant gases can be admitted into the chamber through separate inlets 227, or alternatively, etchant gases can be admitted through inlets used also for precursor gases. However admitted, actual admission of etchant gases is preferably controllable, e.g., by controllable valves 229 (or mass flow controllers, or the like).

Further preferred features are directed to monitoring the amount or extent of undesired deposits so that growth can be interrupted automatically and without operator delay upon accumulation of excessive deposits. Accumulation of undesired deposits can be optically monitored, since such deposits generally reflect light, or absorb light, or both, and since levels of reflectance or absorption generally depend to at least some degree on the level of undesired deposits. Accordingly, exemplary optical sensors 237a and 237b are arranged to measure either light reflectance at the quartz walls of reaction chamber 11, or light transmission through the walls and across the chamber, or both, and to provide signals 241 to the control systems 239. In further embodiments, details of reflection and absorption such as reflectance at selected angles or absorption at selected frequencies, can be measured in order to improve sensitivity and selectivity of deposit monitoring. Also, accumulation of undesired deposits on selected components internal to the reactor chamber can be optically monitored using light focused on the selected components.

Alternatively, the presence and amount of undesired deposits can be indirectly sensed by their effects on the reactor chamber and its internal components. For example, undesired deposits can be sensed by measuring the increased temperature of the walls of reactor chamber 11, because such deposits on the walls of reactor chamber 11 absorb IR radiation from lamps 247 and thereby increase the wall temperature. Also undesired deposits can be sensed by measuring changes in the operating characteristics of a reactor chamber. Undesired deposits on a rotating susceptor and its supports can increase friction or change other rotational characteristics of the susceptor. Undesired deposits can partially occlude gas inlet ports, exhaust ports, and the like, and measurably change the characteristics of gas flow through these ports.

Further preferred features are directed to monitoring the progress of reactor cleaning so that cleaning can be interrupted automatically and without operator delay when the reactor chamber is sufficiently clean. Cleaning can be monitored by the same means used to monitor accumulation of unwanted deposits. For example, cleaning can be interrupted when signals from the above-described optical sensors indicate that little or no undesired deposits remain in the reactor chamber. Preferably, however, cleaning is monitored by sensing or sampling the composition of gases exhausted from the reactor chamber during the cleaning step. These gases include products of the reaction between the etchant gases and the undesired deposits, and it is believed that, when cleaning nears completion, the concentration of these reaction products will decrease towards trace amounts or even to zero. Accordingly, FIG. 2 illustrates analyzer 235 arranged to sense or sample the composition of the gases passing into exhaust 233 of the reactor chamber.

Suitable chemical analyzers can be based on known chemical analysis technologies, in particular, on analysis of various types of spectra. For example, infrared (IR) spectra of gases passing through the exhaust line can be used to determine the concentration of selected species in the exhaust, since such spectra reveal the distinctive vibration signatures of chemical species in the exhaust. For example, reaction products of undesired deposits including GaN (or other Group III-nitride) with etchant gases including HCl typically contain various Ga-chloride (or other Group III-chloride) species which have distinctive vibration signatures detectable in an IR spectrum. Accordingly, analyzer 235 can include an IR spectrometer such as a Fourier Transform IR (FTIR) spectrometer. In addition, UV absorption spectral techniques could be utilized as supplementary optical techniques. Further, mass spectra can distinctively identify reaction products. Accordingly, analyzer 235 can include a mass spectrometer such as a time-of-flight spectrometer, a quadrupole spectrometer, or other type of mass spectrometer.

Further preferred features are directed to performing, automatically and with little or no operator attention, substrate (more generally, work item) removal prior to chamber cleaning and replacement subsequent to chamber cleaning One such feature is robot arm 231, or similar, which is controlled by controller 231a so as to cause the arm to execute a sequence of actions which physically remove a substrate from the interior of a reactor chamber to an exterior location, and also physically replace the substrate from the exterior location back into the interior of reactor chamber. The robot arm can employ front or backside wafer pick-up techniques. In preferred embodiments and for high temperature applications, the robot is fitted with a pick-up wand operating on the Bernoulli principle (Bernoulli wand 233). See, e.g., U.S. Pat. No. 5,080,549, which is incorporated herein by reference in its entirety for all purposes. A Bernoulli wand utilizes downward jets of gas towards the substrate to create a region of low pressure above the substrate leading to a pressure difference across the substrate that lifts and holds a typically hot substrate without contacting the substrate. Bernoulli wands can reduce substrate contamination and temperature gradients in comparison to pick-up devices that physically contact the substrate.

Additional preferred substrate removal/replacement features cooperate with the robot arm and Bernoulli wand to provide automatic access to the reactor chamber, e.g., load lock 215, and handling of the substrate when it is removed from the reactor, e.g., intermediate transfer (or load) chamber 213 and associated components. Load lock 215 includes a door that can be automatically closed to seal the reactor chamber during growth and cleaning, and also can be automatically opened to allow the robot arm access to a substrate within the reactor chamber. When interior to the reactor chamber during growth, substrates are usually supported on a substrate holder, such as susceptor 217. When exterior to the reactor during cleaning, substrates can be supported on a substrate holder, e.g., substrate holder 245 within the load chamber or holder 251 without the load chamber, or held by the robot arm. Robot arm 231 can access substrate holder 251 through automatically controllable rear lock door 216 between load chamber 213 and exterior 249.

The load chamber and associated components can perform further functions useful to improving substrate transfer speed. See, e.g., U.S. Pat. No. 6,073,366, which is incorporated herein by reference in its entirety for all purposes. For example, the load chamber and load lock door can then function similarly to an air lock. Prior to opening the load lock door leading to the reactor chamber, the load chamber atmosphere can be controlled to have a pressure substantially equal to the pressure of the reactor chamber atmosphere, or to have a composition that does not react with the reactor chamber atmosphere and the reactor chamber contents (e.g., is inert), or to be otherwise compatible with the reactor chamber atmosphere.

Similarly, prior to opening the rear lock door, the load chamber atmosphere can be controlled to have substantially atmospheric pressure, to have no toxic components, or the like. Although, preferably, a substrate is retained in the load chamber when removed from the reactor chamber, and the load chamber has an atmosphere controlled so as not to react with the substrate, or to hinder further material growth, or the like.

Further preferred features include control systems 239 for automatically carrying out the methods of this invention with little or no operator intervention. Accordingly, the control systems receive sensor signals 241 preferably the progress of reactor chamber cleaning, and in dependence on the received sensor signals, provide control signals to robot arm controller, load lock door, etchant gas inlet in such a manner that the methods of this invention are carried out. Also the control systems can receive sensor signals monitoring the accumulation of undesired deposits. Control system 239 can also monitor and control other aspects of the operation of the reactor chamber and reactor chamber subsystems not specifically related to the methods of this invention. For example, control system 239 can also monitor and control reactor temperature, reactor pressure, precursor flow rates, and other aspects of the growth process. Control system 239 generally includes memory, storage, programmable devices, e.g., microprocessors, and the like. The control system also preferably includes user interface facilities, e.g., keyboard, display, and so forth.

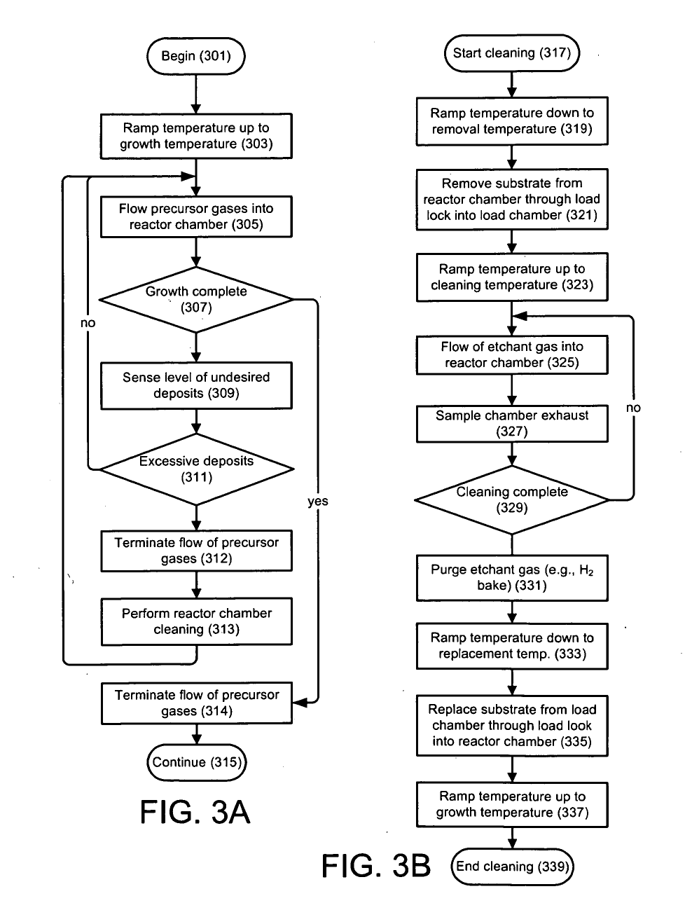

FIGS. 3A-B illustrate in detail implementations of the methods of FIGS. 1A-B using the reactor chamber subsystem of FIG. 2 that can be performed by control system 239. It is to be understood that the illustrated implementation is an example and is not to be considered as limiting. One of ordinary skill in the art, from these figures and following description, will appreciate alternative combinations and arrangements of the illustrated steps, and more generally, how the illustrated steps can be adapted and implemented on other reaction chamber subsystems. These alternatives are within the scope of this invention.

FIG. 3A generally illustrates an epitaxial growth process into which the cleaning methods of this invention have been incorporated and integrated. FIG. 3B then illustrates in detail these cleaning methods. Turning first to FIG. 3A, the growth process generally illustrated therein begins 301 when the controller, e.g., control system 239, establishes growth conditions in the reactor chamber by, among other actions, activating heating lamps 247 to ramp up temperature 303 to epitaxial growth temperatures. Upon reaching growth temperatures, the control system causes precursor gases to flow into the reactor chamber by, e.g., activating precursor inlets 219 and 223 and precursor-inlet valves 221 and 225 so that precursor gases flow into the chamber at proper rates and pressures. Epitaxial growth occurs when the precursor gases react at the heated substrate. Growth can be monitored by known methods, and when the growth is complete 307, e.g., when a sufficiently thick layer of material has been deposited, the controller terminates precursor gas flow 314 and continues 315.

The cleaning methods of this invention can be incorporated and integrated into this known process as follows. The controller continuously or intermittently senses the level of undesired deposits 309 in the reactor chamber, and when it determines that excessive undesired deposits 311 have accumulated, it terminates precursor gas flow 312 and performs reactor cleaning 313 according to this invention as illustrated by FIG. 3B. When reactor cleaning is complete, the controller resumes epitaxial process 305 if necessary 307, otherwise it continues 315 with further steps. As described, the level of undesired deposits is preferably sensed by deposition sensors 237, and the controller uses signals 241 from these sensors to determine whether or not excessive undesired deposits have accumulated. Alternatively, the level of undesired deposits can be determined by operator inspection.

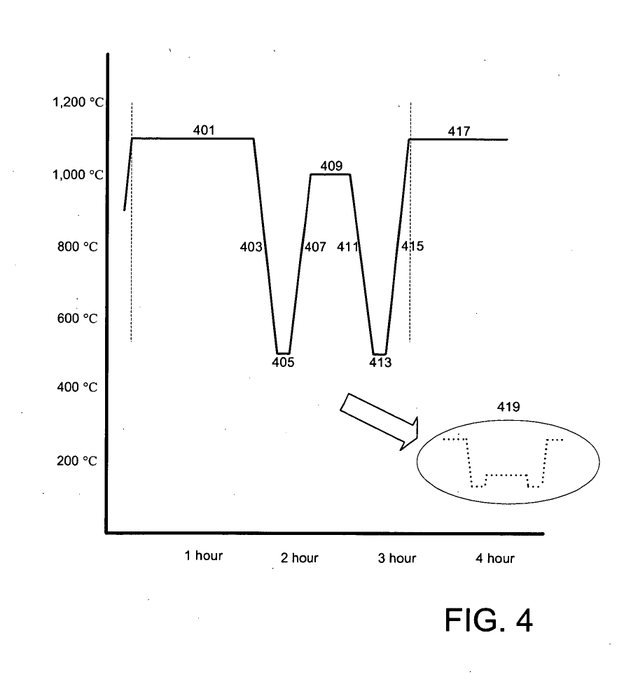

Reactor cleaning 313 is preferably also controlled by control system 239 (or another specialized control system). FIG. 3B illustrates in detail an exemplary cleaning process which generally comprises three groups of sequentially-performed steps: removal of the substrate from the reactor, performed by steps 319 and 321; removal of undesired deposits, performed by steps 323, 325, 327, 329, 331, and 333; and replacement of the substrate back into the reactor, performed by steps 335 and 337. In many embodiments, these three groups of steps are performed at different temperatures. FIG. 4 illustrates an exemplary temperature profile of such an embodiment, particularly when integrated into a Group III-nitride, e.g., GaN, growth process. Here, epitaxial growth, steps 401 and 417, are performed at high growth temperatures. Removal of undesired deposits, step 409, is generally also performed at high temperatures which can be up to and beyond the growth temperature. In practice higher temperatures during the cleaning cycle result in a more rapid removal of unwanted deposited due to an increased reaction rate between the etchant and deposit. However, removal/replacement, steps 405 and 413, for select substrates are often performed at substantially lower temperatures in order to avoid thermal damage to the substrate and materials grown thereon.

Such thermal damage is usually caused by surface decomposition or thermal stresses. If the stresses become excessive, the substrate can distort, e.g., by bowing or otherwise. If the substrate comprises layers having different coefficients of thermal expansion (CTE), the layers can crack or flake. In preferred embodiments of the invention external heating can be supplied to the substrate upon removal from the reactor to prevent damaging thermal shock. Alternatively heating elements can be housed within the transfer (load) chamber itself, although modification to internal components of the chamber maybe required to prevent component damage due to excessive temperatures. Alternatively, such thermal damage is avoided by preferably limiting rates of temperature change in the reactor chamber and also by lowering the reactor chamber temperature to nearer the ambient temperature (in the load chamber) when the substrates are moved in and out of the chamber. Accordingly, FIG. 4 illustrates that the removal/replacement temperatures 405 and 413 are considerably lower than the higher growth and cleaning temperatures 401, 409, and 417. FIG. 4 also illustrates that temperature ramp down 403 and temperature ramp up 415, are sufficiently slow, in order to prevent excessive stresses in growth wafers. The ramp rates for process steps 407 and 411 are not restricted by the thermal properties of the working substrate since the wafer is positioned external to the reactor in the load chamber during the cleaning cycle. Therefore, ramp rates for steps 407 and 411 are limited only by the heating/cooling rate of the reactor itself, in preferred embodiment the heating rate is greater than 100° C./min, whilst the cooling rate is greater than 75° C./min.

It should be understood that the times and temperatures illustrated in FIG. 4 are for illustrative purposes only and are not to be taken as limiting. For example, the growth temperature range of 900-1150° C., and the cleaning temperature range of 1000-1,150° C. are suitable for Group III-nitride, e.g., GaN, growth. For other materials these temperatures can be different. For example, for SiC, etc., temperatures are likely to be higher than the above, and for GaAs, etc., temperatures are likely to be lower than the above. Different substrates can require lower or tolerate higher removal/replacement temperatures, and for certain substrates replacement/removal temperatures may need to be a low as 250° C. while for others they can be as high as 900° C. Also replacement and removal temperatures can be different. Also, the replacement/removal times are illustrated for the automated reactor chamber subsystem of FIG. 2 or similar. If the reactor chamber subsystems include semi-automatic or manual removal/replacement mechanism, these steps may require considerably more time and may need to be conducted at lower temperatures. Alternatively, other automatic reactor chamber subsystems may be able to perform these steps more rapidly. For example, if the sensors can measure the rates of deposit accumulation or decline of reaction product concentration, the times to commence cleaning and resume growth can be predicted and certain actions performed in advance.

One growth-cleaning cycle is now described. FIG. 3B illustrates exemplary process steps, and the portion of FIG. 4 between the vertical dashed lines illustrates an exemplary thermal profile. Growth period 305 (FIG. 3A) begins after a prior cleaning period and is illustrated to extend 401 (FIG. 4) for about 60 min. at a temperature of about 950° C. At that time, it is determined 309 that excessive undesired deposits have accumulated 311, and the flow of precursor gases is terminated 312 and cleaning period 313 begins.

The cleaning process itself starts 317 with the first group of steps, steps 319 and 321, when control system 239 allows the reactor chamber temperature to ramp down 319 to a removal temperature which is illustrated as abut 500° C. This 600° C. temperature decline 403 is illustrated to require about 15 min. Next, the control system removes the substrate 321 by generating control signals 243 that in turn: open load lock door 215; instruct robot arm controller 231a to extend robot arm 231 through the open load lock door into reactor chamber 211; cause Bernoulli wand 233 to pick up the working substrate from susceptor 217; instruct the robot arm controller to retract the robot arm back into load chamber 213; and to close the load lock door. The substrate now held by the Bernoulli wand can optionally be placed on substrate holder 245 inside the load chamber (or on substrate holder 251 outside of the load chamber). The substrate holder can optionally be configured to buffer the temperature change of a working substrate. See, e.g., U.S. Pat. No. 6,893,507, which is included here by reference in its entirety for all purposes. Removal/replacement of the working substrate is illustrated here to require 1-2 min at 500° C.

Next, the second group of steps, steps 323, 325, 327, 329, 331, and 333, perform the actual removal of the undesired deposits. Cleaning is carried out at a higher cleaning temperature, which is illustrated 409 as about 1100° C., and accordingly the control system ramps 323 up the reactor chamber temperature from the lower removal/replacement temperature to the higher cleaning temperature. This ramp up 407 is illustrated as requiring about 6 min. Etchant gases can now be flowed 325 (in preferred embodiments) through the reactor chamber at selected flow rates and pressures to react with the undesired deposits forming gaseous products. Alternatively, a number of short cleaning cycles can be repeated, each cycle including admitting an aliquot of etchant gas into the chamber, retaining the gas in the chamber for a period of time, and then exhausting the gas. As an additional alternative, a chemically reactive plasma could be generated within the reactor chamber, e.g. by the application of a radio frequency electromagnetic field to the etchant gases, thereby creating high energy ionic species.

As described, the control system automatically monitors cleaning progress by, preferably, sampling the exhaust gases 327 from the reactor to determine the level of products of the cleaning reaction. If this level indicates that the reactor chamber is sufficiently clean 329, e.g., by falling below a threshold (or down to a trace level), the control system terminates the flow of etchant gas. The cleaning period 409 is here illustrated to be about 15 min. The etchant gases are preferably purged 331 from the reactor chamber prior to proceeding on to further growth by, e.g., flowing a purging gas through the chamber. In the case of GaN, H₂ is preferably the purging gas and the reactor chamber is heated when the H₂ is in the chamber. Next, the control system allows the reactor chamber temperature to ramp down 333 to the removal/replacement temperature range 413. This ramp down is illustrated as requiring about 9 min.

The last group of steps, steps 335 and 337, prepares the reactor chamber for a further period of epitaxial growth (if needed). The control system replaces the substrate back into reactor chamber 335 by controlling the load lock door and the robot arm to move the working substrate from the load chamber 335 (or from substrate holder 251 exterior to the load chamber) and place it on the susceptor in the reactor chamber. Other than being performed in a reverse order, the details of the replacement step 335 are essentially the same as those of removal step 321 and are not further described. Substrate replacement 413 is illustrated as requiring about 1-2 min., but may require a longer time if it includes semi-automatic or manual steps. Next, the reactor chamber temperature is ramped up 337 back to growth temperature 417, again illustrated as requiring about 15 min.

It is apparent from FIG. 4 that a significant amount of time during the cleaning process is spent in the subsidiary steps of ramping the temperature and removing/replacing the substrate. During these times, neither can material be grown on the substrate nor can undesired deposits be removed from the chamber, and it is advantageous to perform these subsidiary steps quickly. As described, the removal/replacement step can be quickly and reliably carried out by automating the essentially mechanical manipulations necessary for substrate removal and replacement steps. The time spent ramping the temperature could be reduced if the rates of temperature changes could be higher, or if the replacement/removal temperatures could be closer to the growth/cleaning temperatures. For example, dotted trace within callout 419 illustrates the temperature profile of a complete cleaning cycle in which the removal/replacement temperatures were about 850° C. (other parameters of the cleaning cycle remaining unchanged). This duration of this cleaning cycle is only about 55-60% of the duration of the original cleaning cycle (where the removal/replacement temperatures were about 500° C.).

Since, as discussed, the rates of temperature change and the removal/replacement temperatures are largely determined by the ability of the working substrate to withstand thermal stress, use of more thermally-resistant substrates is advantageous and a preferred approach for increasing the efficiency of the cleaning steps of this invention. Generally, it is preferable that the substrates and materials grown thereon (more generally, working materials used in a growth processes) be adapted to repeated transfer between a higher-temperature reactor chamber and a lower-temperature load chamber with little of no damage (that is, any damage does not impair intended uses of the working materials).

The response of a substrate to thermal stresses depends in part on its coefficient of thermal expansion (CTE). In certain preferred embodiments of the present invention, working substrates are substantially planar layers of a base substrate material on which are grown one or more further layers. If the CTEs of the various layers are sufficiently different or are sufficiently high, then lower thermal stresses or slower rates of temperature change can lead to differential thermal expansion sufficient to cause substrate damage. Therefore, substrates and the materials grown thereon advantageously have CTEs that are sufficiently low or sufficiently matched (in the case of heterogeneous materials) so that they can withstand higher thermal stresses and higher rates of temperature change without damage. For example, such substrates can be removed or replaced in a reactor chamber with a temperature greater than about 600° C., or about 700° C., or up to about 850° C. and higher.

CTEs can be matched in several ways. In one approach, a material can be grown on a base substrate of the same or a closely related material. For example, GaN (and other Group III-nitrides) can be grown on a base substrate of GaN itself, or GaN can be grown on a base substrate layer of, e.g., AlN which has a crystal structure and a CTE closely matched to those of GaN. See, e.g., U.S. Pat. No. 5,909,036, which is included herein by reference in its entirety for all purposes. In another approach, a composite base substrate can be constructed of one or more materials having CTEs matched to the material to be grown thereon and one or more other materials having crystal structures matched to the growth material. These materials are arranged so that the surface of the composite substrate is matched to the growth material in both CTE and crystal structure. For example, in the case of GaN (or other Group III-nitrides), a composite substrate can comprise two or more layers with the CTEs of upper layers (or layer) being increasingly better matched to the CTE of GaN and a, perhaps thin, surface layer with a crystal structure matched to GaN. See, e.g., U.S. Pat. No. 6,867,067 and US 2004/0235268.

### Example of Cleaning a Reactor Growing GaN

For a typical cleaning process the robot arm will remove the growth wafer from the reactor chamber to the load-lock in a time period of less than one minute. The reactor chamber is heated to a temperature of between 650° C.-1200° C. Hydrogen flows into the chamber in conjunction with HCl vapor for more efficient activation of the etching species. Preferred embodiment also utilizes a dual flow process for optimized removal of reactor deposits. Initially, a low flow regime (5-10 slm H₂+HCl, ration H₂:HCl from 1:2 to 1:5) is employed to allow for the etchant species to diffuse through the entirety of the reactor chamber, ensuring that the etchant species can contact all areas of the reactor. For the second flow regime, the total flow rate is increased (10-40 slm H₂+HCl, ration H₂:HCl from 2:1 to 10:1). The high flow rate regime allows for the etching of material further downstream from the heated susceptor; in addition the high flow rate physically removes large particulates from the chamber walls. The total time period for cleaning of the chamber is between 5-30 minutes as determined from the signature of etch products from the FTIR analyzer. The growth wafer can then be reloaded for further nitride deposition.

The preferred embodiments of the invention described above do not limit the scope of the invention, since these embodiments are illustrations of several preferred aspects of the invention. Any equivalent embodiments are intended to be within the scope of this invention. Indeed, various modifications of the invention in addition to those shown and described herein, such as alternate useful combinations of the elements described, will become apparent to those skilled in the art from the subsequent description. Such modifications are also intended to fall within the scope of the appended claims. In the following (and in the application as a whole), headings and legends are used for clarity and convenience only. A number of references are cited herein, the entire disclosures of which are incorporated herein, in their entirety, by reference for all purposes. Further, none of the cited references, regardless of how characterized above, is admitted as prior to the invention of the subject matter claimed herein.

What is claimed is:

1. A method for controlling undesired deposits of semiconductor material in a reaction chamber for producing the same, which comprises:
producing a semiconductor material on a substrate; and
removing undesired deposits within the reactor chamber by an in situ cleaning process, either by:
(a) repeating the producing and removing in a manner so that the selected amount of semiconductor material is provided on the substrate while the amount of undesired deposits in the reactor chamber is maintained within an acceptable range; or
(b) exposing the reactor chamber interior to one or more cleaning gases which react with the undesired deposits to form gaseous reaction products; automatically detecting levels of the gaseous reaction products; and continuing gas exposure in the reaction chamber until the automatically detected levels of reaction products indicate that the amount of undesired deposits is within an acceptable range.

2. The method of claim 1 wherein the in situ cleaning process comprises:
growing a selected amount of the semiconductor material on the substrate in the reactor chamber by a chemical vapor deposition (CVD) process; and
removing undesired deposits within the reactor chamber by repeating the growing and removing steps until the selected amount of material is grown on the substrate and the amount of undesired deposits in the reactor chamber is maintained within the acceptable range.

3. The method of claim 2 further comprising maintaining the substrate in controlled conditions out of contact with the ambient atmosphere until the selected amount of semiconductor material has been grown on the substrate.

4. The method of claim 2 wherein the CVD process comprises a hydride vapor phase epitaxy process, the semiconductor material grown on the substrate comprises one or more compounds of one or more Group III elements and the in situ cleaning process comprises converting undesired deposits to gaseous products which are exhausted from the reactor chamber.

5. The method of claim 2 wherein the acceptable range of undesired deposit accumulation is such that the material grown on the substrate has a quality sufficient for its intended use.

6. The method of claim 2 wherein the acceptable range of accumulation undesired deposit is such that the material grown on the substrate is substantially free of contamination arising from the undesired deposits.

7. The method of claim 2 further comprising:
detecting automatically the amount of undesired deposits; and
performing the in situ cleaning process in dependence on the automatically detected amount of undesired deposits so that the amount of undesired deposits is maintained within the acceptable range.

8. The method of claim 1 further comprising transferring the substrate from the reactor chamber during the in situ cleaning process, the reactor chamber temperature during substrate transfer being set within a replacement/removal temperature range such that thermal damage to the substrate is not likely.

9. The method of claim 1 wherein the in situ cleaning process comprises:
exposing the interior of the reactor chamber to one or more cleaning gases which react with the undesired deposits to form gaseous reaction products;
detecting automatically levels of the gaseous reaction products; and
continuing the gas exposure until the automatically detected levels of reaction products indicate that the amount of undesired deposits is within an acceptable range.

10. The method of claim 9 further comprising flowing one or more cleaning gases through the reactor chamber, and detecting the levels of gaseous reaction products in the reactor-chamber exhaust gases by performing a spectral measurement, wherein the undesired deposits comprise one or more Group III-V compounds, halide compounds, and wherein the cleaning gases comprise a halogen compound.

11. Processing equipment for growing a selected amount of a semiconductor material on a substrate comprising:
a reactor subsystem comprising a reactor chamber, the subsystem being directed by control signals to carry out various semiconductor processes;
a gas sensor for generating signals responsive to the composition of gases discharged from the chamber; and
an automatic controller for generating control signals to direct the reactor subsystem, the control signals being generated, at least in part, in dependence on the gas sensor signals.

12. The equipment of claim 11 wherein the control signals further comprise cleaning control signals that carry out an in situ process for cleaning undesired deposits from within the reactor chamber, and wherein the in situ cleaning process is continued until the gas-sensor signals indicate that the remaining amount of undesired deposits within the reactor chamber is within an acceptable range.

13. The equipment of claim 12 wherein the in situ cleaning process further comprises:
exposing the reactor chamber to one or more cleaning gases that react with the undesired deposits within the reactor chamber to form gaseous reaction products; and
discharging the reaction products from the reactor chamber.

14. The equipment of claim 12 wherein the control signals further comprise growth control signals that carry out a CVD processes for growing semiconductor material on the substrate within the chamber, and wherein the controller repetitively generates the growth-control signals and the cleaning control signals in a manner so that the selected amount of material is grown on the substrate while the amount of undesired deposits in the reactor chamber is maintained within the acceptable range.

15. The equipment of claim 14 further comprising a deposit sensor for generating signals responsive to undesired deposits within the reactor chamber, and wherein the CVD process is continued until the deposit-sensor signals indicate that the reactor chamber should be cleaned.

16. The equipment of claim 14 wherein the CVD process further comprises:
heating the reactor to a growth temperature range; and
flowing through the reactor chamber one or more precursor gases that react to deposit the semiconductor material on the substrate.

17. The equipment of claim 16 wherein the precursor gases comprise a halogen compound of a Group III element, and wherein the growth temperature range is from about 800° C. to about 1150° C.

18. The equipment of claim 12 further comprising a load chamber having a controlled atmosphere where the substrate resides during an in situ processes and a substrate-transfer means directed by transfer control signals for performing a processes for transferring a substrate into or out of the reactor chamber, the substrate being transferred out of the reactor chamber prior to the in situ cleaning process and transferred back into the reactor chamber subsequent to the in situ cleaning process.

19. The equipment of claim 18 wherein the substrate-transfer means further comprises a robot arm and the transfer process further comprises maintaining the reactor at a replacement/removal temperature during the substrate transfer, the replacement/removal temperature being such that thermal damage to the substrate during transfer is unlikely.

20. The equipment of claim 19 wherein the replacement/removal temperature is from about 600° C. to about 750° C.
